(19) United States
(12) Patent Application Publication
(10) Pub. No.: US 2009/0165678 A1
(43) Pub. Date: Jul. 2, 2009

(54) HEAT INSULATION BOARD MADE FROM FLY ASHES

(75) Inventor: Li Wang, Beijing (CN)

Correspondence Address: YING CHEN;Chen Yoshimura LLP, 255 S. GRAND AVE., # 215, LOS ANGELES, CA, 90012, US

(73) Assignee: BEIJING HENGYECUN S&T CO., LTD, Beijing (CN)

(21) Appl. No.: 11/967,168

(22) Filed: Dec. 29, 2007

(30) Foreign Application Priority Data
Dec. 27, 2007 (CN) 200710304328.2

(51) Int. Cl. C04B 14/42; C04B 16/04

(52) U.S. Cl. 106/646; 106/676

(57) ABSTRACT

The invention relates to a kind of fly ash heat preservation board. It is made of mixed foam slurry and stuff solid in the mould. Main materials of the stuff include light burring magnesium powder, magnesium chloride solution, fly ash, oxalic acid and glass fiber. Proportion of main materials of the above-mentioned stuff is: fly ash 200 portions, light burning magnesium powder 100-150 portions, oxalic acid 1-2 portions, glass fiber 5-15 portions. Wherein said magnesium chloride is 28-32 Degree Baum'e magnesium chloride water solution, the addition quantity is 40-75 portions. Wherein said vesicant is animal protein vesicant, foam diameter should be controlled between 0.1˜1 mm, it can be maintained naturally after being mounded. The invention improve anti-pressure intensity of board, which benefits for increasing foam quantity, lowing board density and improving heat preservation performance.

### BACKGROUND OF THE INVENTION

1. Field of the Invention

The invention related to a kind of fly ash heat insulation boards which belongs to field of building materials.

2. Description of the Related Art

The existing fly ash heat insulation board made of mixed foam slurry and stuff solid in the mould. Concrete stuff is made with cement as main materials; foam slurry is made by foaming chine with vesicant, then pours concrete stuff and foam slurry into the mould after they are mixed. A kind of board is formed accordingly and will be maintained naturally, which realize heat insulation by way of heat insulation of the board. While, this kind of board is short of strength, hence the heat insulation effect is limited.

### SUMMARY OF THE INVENTION

The invention involves a kind of fly ash heat insulation board. It is made of mixed foam slurry and stuff solidifed in the mould. Main materials of the stuff include light burring magnesium powder, magnesium chloride solution, fly ash, oxalic acid and glass fiber. Proportion of main materials of the above-mentioned stuff is: fly ash 200 portions, light burning magnesium powder 100-150 portions, oxalic acid 1-2 portions, glass fiber 5-15 portions. Wherein said magnesium chloride is 28-32 Degree Baum'e magnesium chloride water solution, the addition quantity is 40-75 portions. Wherein said vesicant is animal protein vesicant, foam diameter should be controlled between 0.1˜1 mm, it can be maintained naturally after being mounded. The invention improve anti-pressure intensity of board, which benefits for increasing foam quantity, lowing board density and improving heat insulation performance.

In order to overcome the deficiency of exiting technology, this invention provides a kind of fly ash heat insulation board which has high strength and provides heat insulation by increasing foam quantity.

The technical plan of the above invention is: a kind of fly ash heat insulation board made of mixed foam slurry and stuff solidified in the mould. Main materials of the stuff include light burning magnesium powder, magnesium chloride solution, fly ash, oxalic acid and glass fibre.

The proportion of wherein said stuff is: fly ash 200 portions (quality portions, the same below), light burning magnesium powder 100-150 portions, oxalic acid 1-2 portions, glass fiber 5-15 portions. Wherein said magnesium chloride is 28-32 Degree Baum'e magnesium chloride water solution, the addition quantity is 40-75 portions.

Since highly adhesive light burning magnesium powder and magnesium chloride and active fly ash and glass fiber which will enhance adhesive strength are used in the raw materials in the invention, they improved anti-pressure strength of board and benefit for increasing foam quantity, lowering density of board and improving heat insulation performance. When its dry density is 400 kg/m³, as for all implementation cases given in this explanation, the anti-pressure strength can reach over 2-2.5 Mpa. This kind of heat insulation board can be used as heat preserved faced board of wall body, wall-partition board and roof board. Addition quantity of foam can be prepared according to strength and heat insulation requirement to meet the need of users.

### BRIEF DESCRIPTION OF THE DRAWINGS

FIG. 1 shows the process illustration in the invention

### DETAILED DESCRIPTION OF THE PREFERRED EMBODIMENTS

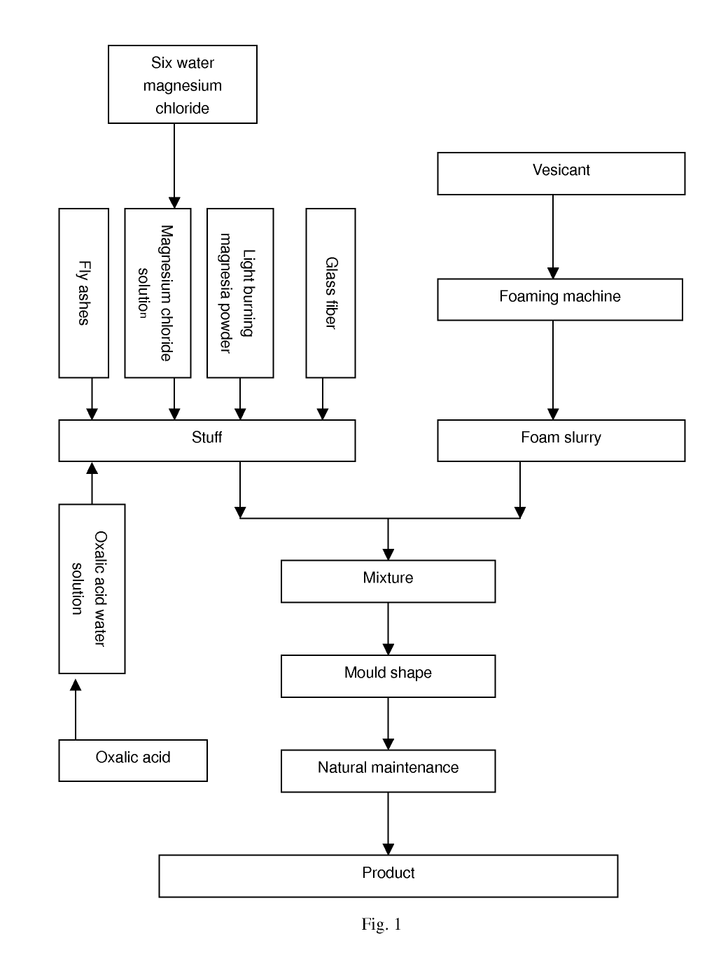

As shown in FIG. 1, the invention provides a kind of fly ash heat insulation board made of mixed foam slurry and stuff solidified in the mould. Main materials of the stuff include light burning magnesium powder, magnesium chloride solution, fly ash, oxalic acid and glass fiber.

The proportion of wherein said stuff is: fly ash 200 portions (quality portions, the same below), light burning magnesium powder 100-150 portions, oxalic acid 1-2 portions, glass fiber 5-15 portions. Wherein said magnesium chloride is 28-32 Degree Baum'e magnesium chloride water solution, the addition quantity is 40-75 portions.

To guarantee enough surface area, preferred number of fineness degree of the fly ash should not be more than 1 mm.

Wherein said optimum light burning magnesium powder is a kind of over 85% light burning magnesium powder.

Wherein said magnesium chloride water solution is confected by no-salt six water magnesium chloride or no water magnesium chloride.

Wherein said oxalic acid will be made into water solution firstly.

The length of wherein said glass fiber is 2-5 mm.

Concrete water-reducing agent should be added in wherein said stuff materials; with the above-mentioned proportion, the addition quantity of wherein said water-reducing admixture is 0.1-0.2 portions.

Wherein said other filling agents are added in the above mentioned stuff. Its addition quantity should not be more than 50 portions; when the filling quantity of these materials is needed to increase, fly ash should be decreased accordingly.

Wherein said foam slurry is made by foaming machine with vesicant, and then pours it into the mould after mixed with stuff fully. It can be maintained naturally.

When choosing wherein said vesicant and foam machine, we should consider stability, average and water permeability of foam as well as if gelatinization of stuff has side effect to form stable foam with fitting and average diameter of foam. The foam should be hard to damage or extremely transform and should have self water-retaining performance to keep thickness and integrality of foam liquid film for a long time. In the process of or after mixing with stuff, it is not easy to break or form connection hole.

Foam diameter of wherein said foam slurry should be controlled between 0.1˜1 mm.

Wherein said vesicant is animal protein vesicant; the foam made of this kind of vesicant has characteristics of good stability which use suitable for low dense or super low dense foam materials. When the mix quantity of foam is very high, it is not easy to defoam and collapse mould. With the existing technology, we can still use compound vesicant by adding foam-increased group division, foam-stable group division, function group division and adjustment group division to achieve better foaming effect. This vesicant can be brought in the market.

Proportion of wherein said foam slurry and stuff should be determined according to density of building materials that are making.

Implementation cases of auxiliary materials of several stuffs are as follows:

Implementation 1:

Fly ash: 200 kg;

Light burning magnesia powder: 100 kg;

Oxalic acid: 1 kg;

Glass fiber: 5 kg

32 Degree Baum'e Magnesium chloride solutions: 75 kg

Water-reducing mixture: 0.1 kg

Implementation case 2:

Fly ash: 200 kg

Light burning magnesia powder: 150 kg

Oxalic acid: 2 kg

Glass fiber: 15 kg

28-32 Degree Baum'e Magnesium chloride solution: 40 kg

Water-reducing admixture: 0.2 kg

Iron ore tailings sand: 50 kg

Implementation 3:

Fly ash: 200 kg

Light burning magnesia powder: 120 kg

Oxalic acid: 1.5 kg

Glass fiber: 10 kg

28-32 Degree Baum'e Magnesium chloride solution: 50 kg

Water-reducing admixture: 0.15 kg

Stone powder: 30 kg

Implementation case 4:

Fly ash: 200 kg

Light burning magnesia powder: 150 kg

Oxalic acid: 1 kg

Glass fiber: 8 kg

28-32 Degree Baum'e Magnesium chloride solution: 35 kg

Stone powder: 50 kg

Implementation case 5:

Fly ash: 200 kg

Light burning magnesia powder: 150 kg

Oxalic acid: 1.2 kg

Glass fiber: 5 kg

28-32 Degree Baum'e Magnesium chloride solution: 40 kg

Water-reducing admixture: 0.05 kg

Stone powder: 30 kg

Iron ore tailings sand: 20 kg

Implementation case 6:

Fly ash: 200 kg

Light burning magnesia powder: 100 kg

Oxalic acid: 2 kg

Glass fiber: 13 kg

28-32 Degree Baum'e Magnesium chloride solution: 40 kg

Water-reducing mixture: 0.2 kg

Stone powder: 10 kg

Iron ore tailings sand: 10 kg

Inorganic mineral powder originated from building rubbish: 10 kg

Furnace slag powder of coal burning boiler: 10 kg

What is claimed is:

1. A fly ash heat insulation board, being made of mixed foam slurry and stuff solidified in the mould, main materials of said stuff including light burning magnesium powder, magnesium chloride solution, fly ash, oxalic acid and glass fibers.

2. A fly ash heat insulation board of claim 1, said board is maintained naturally after being molded.

3. A fly ash heat insulation board of claim 1, wherein main materials of said board is: fly ash of 200 portions, light burning magnesium powder of 100-150 portions, oxalic acid of 1-2 portions, glass fibers of 5-15 portions,

4. A fly ash heat insulation board of claim 1, wherein said magnesium chloride is 28-32 Degree Baum'e magnesium chloride water solution, the addition quantity is 40-75 portions.

5. A fly ash heat insulation board of claim 3, wherein said board is that the degree of fineness is less than 1 mm.

6. A fly ash heat insulation board of claim 3, wherein said board is that wherein said light burning magnesium powder is a kind of over 85% light burning magnesium powder.

7. A fly ash heat insulation board of claim 3, wherein said magnesium chloride water solution is confected by no-salt six water magnesium chloride or no water magnesium chloride, Wherein said oxalic acid should be made into water solution firstly.

8. A fly ash heat insulation board of claim 3, wherein said glass fiber is 2-5 mm in length.

9. A fly ash heat insulation board of claim 3, wherein said board is that concrete water-reducing admixture is added in the above mentioned stuff; the addition quantity of water-reducing admixture is 0.1-0.2 portions.

10. A fly ash heat insulation board of claim 3, wherein said other filling agents are added in the above mentioned stuff, its addition quantity should not be more than 50 portions, said other filling agents include stone powder and iron ore tailings sands.

11. A fly ash heat insulation board of claim 3, wherein said foam slurry is made by foaming machine with vesicant, foam diameter of the foam slurry should be controlled between 0.1˜1 mm. Besides, wherein said vesicant is a kind of animal protein vesicant or compound vesicant by adding foam-increased group division, foam-stable group division, function group division and adjustment group division.

12. A fly ash heat insulation board of claim 2, wherein said proportion of main materials of the above-mentioned stuff is: fly ash 200 portions, light burning magnesium powder 100-150 portions, oxalic acid 1-2 portions, glass fiber 5-15 portions. Wherein said magnesium chloride is 28-32 Degree Baum'e magnesium chloride water solution, the addition quantity is 40-75 portions.

13. A fly ash heat insulation board of claim 11, wherein said light burning magnesium powder is a kind of over 85% light burning magnesium powder.

14. A fly ash heat insulation board of claim 11, wherein said magnesium chloride water solution is confected by no-salt six water magnesium chloride or no water magnesium chloride, Wherein said oxalic acid should be made into water solution firstly.

15. A fly ash heat insulation board of claim 11, wherein said glass fiber is 2-5 mm in length.

16. A fly ash heat insulation board of claim 11, wherein said concreted water-reducing admixture is added in the above mentioned stuff, the addition quantity of water-reducing admixture is 0.1-0.2 portions.

17. A fly ash heat insulation board of claim 11, wherein said other filling agents are added in the above mentioned stuff. Its addition quantity should not be more than 50 portions; the other filling agents include stone powder and iron ore tailings sand.

18. A fly ash heat insulation board of claim 11, wherein said foam slurry is made by foaming machine with vesicant, foam diameter of the foam slurry should be controlled between 0.1˜1 mm. Besides, wherein said vesicant is a kind of animal protein vesicant or compound vesicant by adding foam-increased group division, foam-stable group division, function group division and adjustment group division.
